(19) United States
(12) Patent Application Publication
(10) Pub. No.: US 2006/0150247 A1
(43) Pub. Date: Jul. 6, 2006

(54) Protection of stored data

(76) Inventor: Andrew Gafken, Folsom, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/027,008

(22) Filed: Dec. 30, 2004

(51) Int. Cl. G06F 12/14

(52) U.S. Cl. 726/17

(57) ABSTRACT

An arrangement to protect individual files or data stored in a memory based upon the application attempting a read or write access. A user may set the conditions for access to protected files or directories stored in the memory. When an access to a protected file or directory is made a filter reads the conditions and compares the request with the conditions before allowing access to the files or directories.

### TECHNICAL FIELD

The present subject matter pertains to data control systems and more particularly to protection of data storage media.

### BACKGROUND

The vast amount of computer system data typically resides on a computer's read/write data storage media. Such storage media commonly includes a computer hard disk. An operating system can be adept at maintaining the integrity of a computer system's hard disk data. However, operating systems can be manipulated by some software including computer viruses to over-write valuable data. Therefore, protecting a user's data is of paramount importance. Users demand integrity of their data.

Currently, internet applications and marketing web sites are becoming more aggressive in dealing with a user's hard drive data, unknown to the user. For example, links to an unwanted site can become forced onto the user's hard drive “favorites” lists. “Spy software” may be downloaded into a user's hard drive to monitor a user's habits and report the habits to an unauthorized link, again unknown to the user. Data mining is prevalent which attempts to gather a user's personal data, such as social security, credit card information and other highly personal information.

As hard disks and other readable/writeable memories grow in size, protecting the stored data becomes more important and valuable to users. These memories can be vulnerable to aggressive behavior or attacks from outside sources via remote software that can read or write a user's data.

### DESCRIPTION OF THE DRAWINGS

FIG. 1 is a block diagram of a data storage protection arrangement in accordance with an embodiment in the present invention.

FIG. 2 is a flow chart of a method to protect a data storage arrangement in accordance with an embodiment of the present invention.

### DETAILED DESCRIPTION

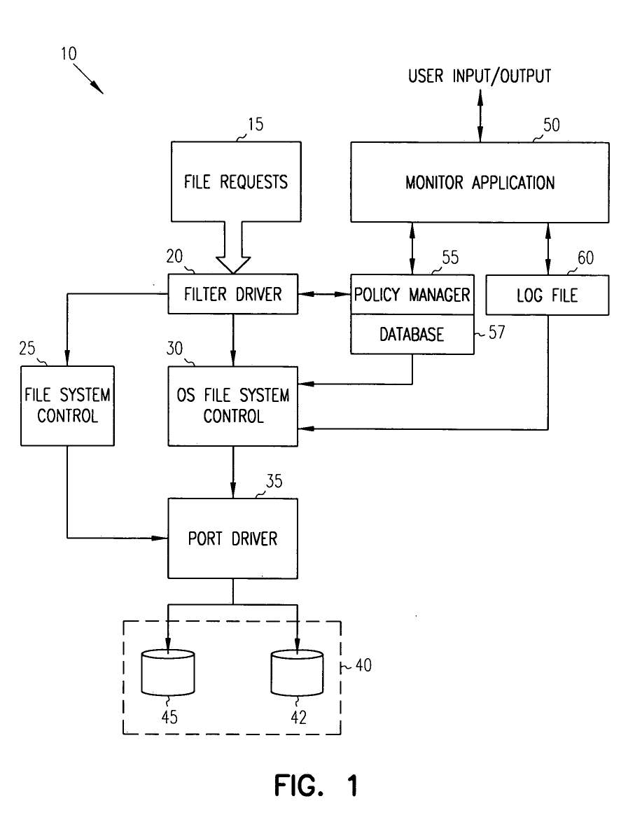

FIG. 1 illustrates an architectural diagram for an example of a stored data protection system 10, according to an example embodiment. In some embodiments, the components of the data protection system 10 are implemented in a device in hardware and in machine-accessible and readable media. The data protection system 10 facilitates protection of stored data and allows user interaction to monitor and revise the protection rules.

As used herein the phrase “device” refers to any machine capable of connecting to a network and includes memory for storing data, including data received from the network and data to be delivered to the network. In an embodiment the network is the internet.

The data protection system 10 includes, among other things, a filter driver 20, a monitor application 50, a policy manager 55 associated with a policy application database 57, a log file 60 and, in some embodiments, a private file system 25.

FIG. 1 is a block diagram of a stored data protection system 10 for a device having data stored in a memory 40 in accordance with an embodiment of the present invention. For example, in FIG. 1, the memory 40 is depicted as having hard disks 42 and 45 which can either be separate partitions of a single hard drive or separate hard drives. In an embodiment, the memory may include random access memory, flash memory, a local hard disk (as shown) or a network hard disk (not shown), magnetic memory, such as tapes, etc. and any other mass memory media.

Monitor application 50 interfaces with the user to allow input and output of information to operate the protection system to allow access to protected files and directories only to the applications attempting to gain access to them. In an embodiment, the monitor application is always running on the system to provide a user interface to the system and to respond to filter driver 20 when messages are to be sent to the user.

Policy manager 55 stores information or conditions input from the user to monitor application 50 relating to allowing or restricting access of particular applications to protected files or directories located in memory 40. In an embodiment, those inputs are stored in data base 57 for policy manager 55. In an embodiment, memory 45 is partitioned from memory 42. Memory 45 is controlled by operating system (OS) file control 30. File system control 25 controls access to a protected partition memory 45 of hard disk 40 via port driver 35. Similarly, OS file control 30 controls access to the unprotected partition 42 of mass memory 40 via port driver 35.

In some embodiments, memory or hard disk 40 does not require partitioning. Partitioning increases the protection provided by the methodology. As shown memory partitions 45 and 42 may be included in the same hard disk or memory 40. File system control 25 controls access to the protected partition memory 45 of hard disk 40 via port driver 35. Similarly, OS file control 30 controls access to the unprotected partition 42 of mass memory 40 via port driver 35. File system control 25 operates in a similar manner to OS file control 30 to locate various files and directories of data on memory 40. OS file control 30 may include a disk operating system, a read only memory operating system, a programmable read only memory and an electronically erasable read only memory.

In an embodiment, private file system control 25 operates in a similar manner to OS file control 30 to locate various files and directories of data on memory 40. OS file control 30, in some embodiments includes one or more of a disk operating system, a read only memory operating system, a programmable read only memory and an electronically erasable read only memory.

Filter driver 20 receives incoming requests from applications external to the device for access to the memory 40, since it “sits atop” OS file control 30 and routes information to it under control of policy manager 55. For requests to access non-protected memory 42, filter driver 20 sends the request 15 to OS file control 30. For requests 15 for access to the protected memory 45, filter driver 20 will obtain appropriate information from data base 57 of policy manager 55 to evaluate the request 15 to allow or deny access to the protected partition memory 45.

Log file 60 stores access requests 15 to various files and directories of memory 40. The user may interrogate the log file 60 in order to determine what accesses have been made or attempted to memory, so that a historical access to the data by various applications and entities may be monitored by the user. In one embodiment, such accesses may be to an access to a file and in other embodiment, the accesses may be to a directory. As mentioned throughout, use of a file includes a directory and use of a directory includes a file.

As an example, let us consider a situation in which a user sets-up a policy via monitor application 50 with policy manager 55 to control access to memory partition 45 for file request 15 made by an external application and received for the device by an internet browser, not shown. The access policy may be, for example, to allow access by the browser to the cache directory of memory partition 45, but restrict access to any other directory on partition 45 of hard disk 40.

If the browser attempted to write to the user's favorites directory, the user may receive a “pop-up” message on the display device, not shown, via monitor application 50. The “pop-up” message might indicate that the browser is attempting to write to the favorites directory and the user could be queried to determine whether the user wish to allow such access. Once the user responds via monitor application 50, filter driver 20 would handle the access request by the browser as directed by the user (allow or deny).

Filter driver 20 is on top of OS file control 30. Filter driver 20 receives incoming requests 15 for access to hard disk 40. Filter driver 20 scans the incoming requests 15 and determines the file name, the path, the name of the application making the access request and access type, either read or write. Filter driver then examiner the data base 57 of policy manager 55 and determines whether there are any access restrictions for this requesting application. If, in an embodiment, the policy of the user is to deny the access, filter driver 20 signals the monitor application 50 via policy manager 55 to ask the user how to proceed, as mentioned above. In another embodiment an access request that is to be denied as falling within the user's policy is denied without asking the user how to proceed. If the access request is allowed, filter driver 20 forwards the request to private file system control 25 for performing the read or write access.

Monitor application 50 has two main functions. First, monitor application 50 provides the user interface for input from the user. Second, monitor application 50 sends outputs to the user under direction from filter driver 20. In an embodiment such outputs request user input on how to proceed in various circumstances.

In the first function above, in an embodiment, the monitor application 50 allows the user to add application and associated policies to data base 57 of policy manager 55. Continuing with the example of an application accessing the device through a browser, the user in an embodiment selects the browser, or a particular application accessed by the browser, as a restricted application. In an embodiment, the user selects the directories to which the browser, or a particular application accessed by the browser, may have access. In an embodiment the user selects whether the browser, or a particular application accessed by the browser is to have certain accesses logged by log file 60.

In an embodiment, when an application and its associated restrictions are added to data base 57, a “finger print” of the images (a hashsum over the application), for example, is formed. In an embodiment, this hashsum can be saved in the data base 57 for protecting the integrity of the application.

In the second function, monitor application 50 may provide multiple levels of output to the user. For example, in an embodiment, a novice mode or an expert mode may be selected by the user. When the monitor application 50 receives an indication from the filter driver 20 that user interaction is required, it sends an appropriate communication seeking a user decision as to whether to allow or deny access to memory partition 45. Depending upon the user's selection, the monitor application 50 may update the policy stored in data base 57 via policy manager 55. In an embodiment, password protection is provided so that a user must input a password in order to affect a policy change or update.

In an embodiment, data base 57 stores one or more of a list of restricted applications, their associated restriction policies, default policies, a “finger print” of the application, and configuration information. In an embodiment, the data base 57 is stored in the protected memory partition 45 with “finger print” protection added to this file.

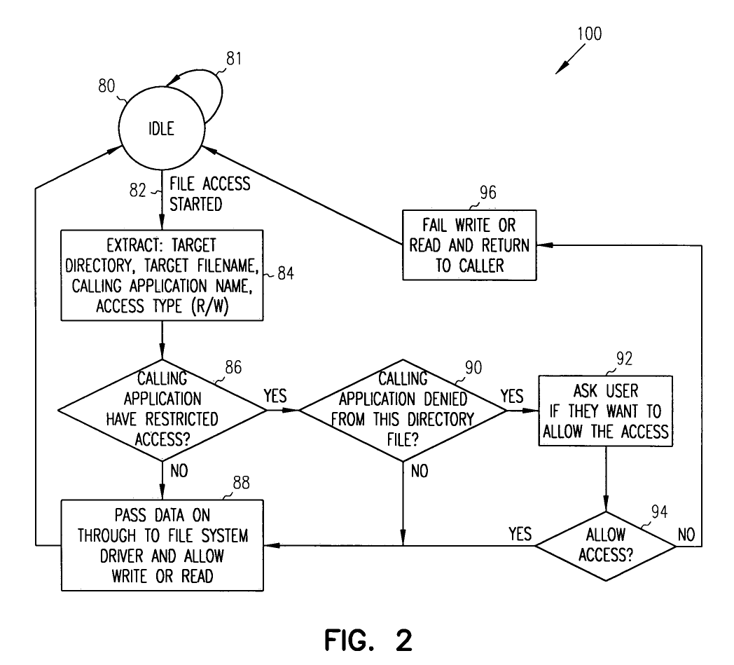

FIG. 2 is a flow chart of a method 100 to protect data storage in accordance with an embodiment of the present invention. This flow chart depicts the operation of filter driver 20 of FIG. 1. Normally the filter driver is in the idle state 80 and is waiting 81 for access requests 15.

When an access request is received 82, block 84 is entered. In an embodiment, the filter driver 20 extracts from the access request: the target directory, the target file name, the requesting or calling application name, and an access type, read or write, block 84.

Next, filter driver obtains the data in data base 57 related to this application name. Filter driver 20 determines whether this application name has any restrictions associated with this access request, block 86. If there are no restrictions associated with the requesting application name, block 86 transfers control to block 88 via the NO path. If the file or directory is located on unprotected partition 42, filter driver passes the request on to OS file control 30. If the file or directory is to the protected partition 45, filter driver passes the request on to file system control 25. File system control interfaces with port driver 35 to perform the requested access. Then block 88 transfers control to the idle state 80 to wait 81 for the next access request.

If the filter driver detected a restriction associated with the requesting or calling application, block 86 transfers control to block 90 via the YES path. Block 90 determines whether the requesting or calling application is denied access to the particular file or directory. If the access is not denied, block 90 transfers control to block 88 via the NO path. Block 88 uses file system control 25 to perform the requested access, since there was some restriction associated with the requesting application as detected by block 86. Then block 88 transfers control to the idle state 80 to wait 81 for the next access request.

If the filter driver determines that this requesting or calling application is denied access to the particular file or directory block 90 transfers control to block 92 via the YES path. Filter driver 20 then indicates to monitor application 50 through policy manager 55 that a user messages should be displayed, do that the user may allow or confirm denial of the requested access, block 92. The user is queried, block 92.

When the user responds, block 92 transfers control to block 94. Block 94 determines whether the user has allowed the access request. If the user input allowed the access request, block 94 transfers to block 88 via the YES path. Block 88 uses file system control 25 to perform the requested access, since the user allowed the requested access. Then block 88 transfers control to the idle state 80 to wait 81 for the next access request. When the user input is received the policy manager 55 can consider updating the data base 57.

If the user denied the requested access, block 94 transfers control to block 96 via the NO path. Block 96 indicates that the access request, read or write, has failed to the requesting or calling application. Then block 96 transfers control to the idle state 80 to wait 81 for the next access request.

As can be seen from the above explanation, the subject methodology provides a user with the ability to protect certain files and directories and data from read or write access by entities which may attempt such accesses without prior knowledge of the user.

The description and the drawings illustrate specific embodiments of the invention sufficiently to enable those skilled in the art to practice it. Examples merely typify possible variations. Portions and features of some embodiments may be included in or substituted for those of others.

Although some embodiments of the invention have been illustrated, and those forms described in detail, it will be readily apparent to those skilled in the art that various modifications may be made therein without departing from the spirit of these embodiments or from the scope of the appended claims.

1. A method comprising:
receiving a request from a requesting application for access to a target file in a memory;
determining if the request is allowable; and
if the request is allowable, accessing by the requesting application the target file in the memory.

2. The method of claim 1, if the request is not allowable, sending a denied indication to the requesting application.

3. The method of claim 1, including setting a protection policy by a user for the target file in the memory.

4. The method of claim 3, wherein determining if the request is allowable includes determining whether an access type of the request is allowable.

5. The method of claim 4, wherein determining includes comparing the protection policy for the file with the request of the requesting application.

6. The method of claim 5, wherein comparing includes determining if the requesting application is to be allowed to access the target file.

7. The method of claim 6, wherein comparing further includes, if the requesting application is to be allowed access, determining if the access type is also allowed.

8. The method of claim 7, if the requesting application is denied access to the target file, determining from the user whether the user will allow access to the target file.

9. The method of claim 8, if the user allows access to the target file, accessing the target file by the requesting application.

10. The method of claim 9, if the user denies the access to the target file, sending a denied indication to the requesting application.

11. The method of claim 10, the determining a target file and access type includes:
determining from the request a target directory;
determining from the request a file name of the target file;
determining from the request the identity of the requesting application, the requesting application being an external application; and
determining from the request a read or a write access type.

12. The method of claim 10, the setting the protection policy by the user includes:
setting one or more identities by the user of requesting applications that are allowed to access the target file;
setting one or more identities by the user of requesting applications that are allowed to access the target directory of the target file; and
setting one or more access types by the user for the requesting application.

13. The method of claim 1, the accessing the file in the memory including accessing the file on a hard disk.

14. The method of claim 1, the accessing the file in the memory including accessing the file on a network hard disk.

15. The method of claim 1, the accessing the file in the memory including accessing the file in flash memory.

16. A machine-readable medium that provides instructions, which when executed by one or more processors, cause the processors to perform operations comprising:
receiving a request from a requesting application for access to a target file in a memory;
determining by a filter from information stored in a data base, if the request is allowable; and
if the request is allowable, accessing by the requesting application the target file in the memory.

17. The machine-readable medium of claim 16, the accessing the file including accessing a data file on a hard disk.

18. The machine-readable medium of claim 16, the accessing the file including accessing a directory on a hard disk.

19. The machine-readable medium of claim 16, further including, if the request is not allowable, determining from a user whether the user will allow access to the file.

20. The machine-readable medium of claim 16, further including, if the user denies the access to the file, sending a denied indication to the requesting application.

21. A system comprising:
a filter to receive a request from an application having a first plurality of parameters to access a file in a memory;
a disk operating system controlling access to an unprotected partition of the memory;
a policy manager to store a second plurality of parameters describing an allowable request for access to a protected partition of the memory;
the filter to determine allowability of a request by comparing the first plurality of parameters with the second plurality of parameters; and
if the request is allowable, the application to access the file independently of the disk operating system.

22. The system of claim 21, wherein there is further included a file system control to access the protected partition of the memory when the filter determines an allowable access to the memory, the file system coupled to the filter.

23. The system as claimed in claim 21, wherein the memory includes a hard disk.

24. The system as claimed in claim 21, wherein the memory includes a network hard disk.

25. The system as claimed in claim 21, wherein the memory includes a flash.

26. The system as claimed in claim 21, further including a monitor application to provide an interface for input and output between a user and the policy manager, the monitor application coupled to the policy manager.

27. The system as claimed in claim 21, the policy manager further including a data base to store the second plurality of parameters on a hard disk.

28. The system as claimed in claim 21, wherein there is further included a log file to record an attempted access to the memory, the log file coupled to the monitor application and to the disk operating system.
